(19) United States
(12) Patent Application Publication
(10) Pub. No.: US 2012/0257302 A1
(43) Pub. Date: Oct. 11, 2012

(54) HARD DISK DRIVE SYSTEM WITH ADSORBENT BREATHER ASSEMBLY PILLAR AND METHOD OF MANUFACTURE THEREOF

(75) Inventors: Haesung Kwon, San Jose, CA (US); Myeong-Eop Kim, Sunnyvale, CA (US)

(73) Assignee: SAMSUNG ELECTRONICS CO., LTD., Gyeonggi-Do (KR)

(21) Appl. No.: 13/082,876

(22) Filed: Apr. 8, 2011

(51) Int. Cl. G11B 33/14; G11B 5/84

(52) U.S. Cl. 360/97.16; 29/603.01; G9B/33.035

(57) ABSTRACT

A method of manufacture of an integrated circuit packaging system includes: providing a base having sidewalls; mounting a magnetic medium for storing data within the sidewalls; mounting an adsorbent breather assembly in direct contact with the base and mounted within the sidewalls without contact therewith; and mounting a cover having an airhole over the base and the sidewalls, in direct contact with the adsorbent breather assembly.

### TECHNICAL FIELD

The present invention relates generally to a hard disk drive system and more particularly to a system with breather assembly for a hard disk drive system.

### BACKGROUND

The rapidly growing market for electronic storage required for email storage, home computing, video games, and laptops is an integral facet of modern life. The enormous quantities of information stored electronically represent one of the largest potential market opportunities for next generation hard disk drives. These hard disk drives have unique attributes that have significant impacts on manufacturing integration, in that they must be generally small, free of vibration, and structurally ridged and they must be produced in high volumes at relatively low cost.

As an extension of the semiconductor industry, the electronics data storage industry has witnessed ever-increasing commercial competitive pressures, along with growing consumer expectations and the diminishing opportunities for meaningful product differentiation in the marketplace.

As a result, the road maps are driving electronic data storage to precision, ultra miniature form factors, which require automation in order to achieve acceptable yield. These challenges demand not only automation of manufacturing, but also the automation of data flow and information to the production manager and customer.

Many industry road maps have identified significant gaps between the current semiconductor capability and the available supporting electronic storage technologies. The limitations and issues with current technologies include read and write speeds, data density, reliability and cost.

In view of the ever-increasing commercial competitive pressures, along with growing consumer expectations and the diminishing opportunities for meaningful product differentiation in the marketplace, it is critical that answers be found for these problems. Additionally, the need to reduce costs, reduce production time, improve efficiencies and performance, and meet competitive pressures, adds an even greater urgency to the critical necessity for finding answers to these problems.

Thus, a need remains for vibration resistant more robust storage packages and methods for manufacture. Solutions to these problems have been long sought but prior developments have not taught or suggested any solutions and, thus, solutions to these problems have long eluded those skilled in the art.

### DISCLOSURE OF THE INVENTION

The present invention provides a method of manufacture of a hard disk drive system including: providing a base having sidewalls; mounting a magnetic medium for storing data within the sidewalls; mounting an adsorbent breather assembly in direct contact with the base and mounted within the sidewalls without contact therewith; and mounting a cover having an airhole over the base and the sidewalls, in direct contact with the adsorbent breather assembly.

The present invention provides a hard disk drive system including: a base having sidewalls; a magnetic medium for storing data mounted within the sidewalls; an adsorbent breather assembly mounted in direct contact with the base and mounted within the sidewalls without contact therewith; and a cover having an airhole mounted over the base and the sidewalls, in direct contact with the adsorbent breather assembly.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is an exploded isometric view of a hard disk drive system in an embodiment of the present invention.

FIG. 2 is an isometric view of the adsorbent breather assembly of FIG. 1.

FIG. 3 is a cutaway isometric view of the hard disk drive system along the line 3-3 of FIG. 1.

FIG. 4 is a cutaway isometric view of the hard disk drive system along the line 4-4 of FIG. 1.

FIG. 5 is a flow chart of a method of manufacture of the hard disk drive system of FIG. 1 in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation.

For expository purposes, the term “horizontal” as used herein is defined as a plane parallel to the plane or surface of the magnetic medium, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane, as shown in the figures. The term “on” means that there is direct contact between elements without having any intervening material.

The term “processing” as used herein includes deposition of material, patterning, exposure, development, etching, casting, cutting, cleaning, and/or removal of the material as required in forming a described structure.

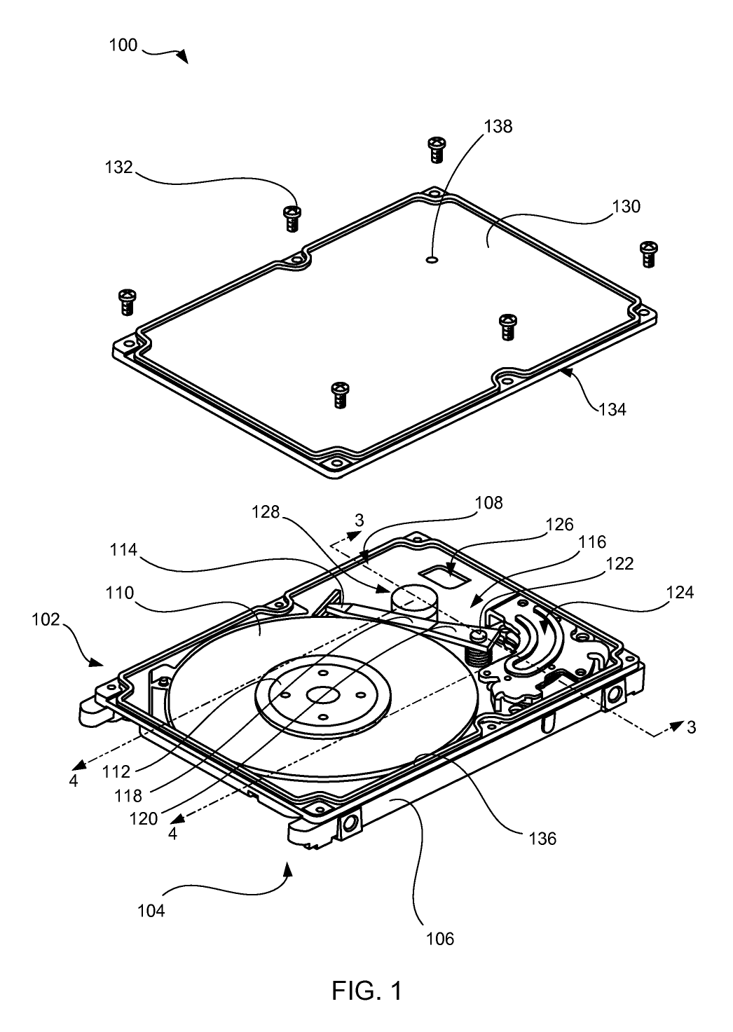

Referring now to FIG. 1, therein is shown an exploded isometric view of a hard disk drive system 100 in an embodiment of the present invention. The hard disk drive system 100 is shown having a base 102 such as a casted aluminum base. Further, the base 102 may be manufactured from materials other than aluminum and utilizing methods other than casting.

The base 102 is shown having a bottom portion 104 with sidewalls 106 around a perimeter of the base 102 and that form an interior recess 108, within which, the disk components may be mounted and protected from external forces. Within the recess 108, a magnetic medium 110 and a spindle motor 112 are mounted.

The magnetic medium 110 functions to store data while the spindle motor 112 rotates the magnetic medium 110 during read/write phases. The magnetic medium 110 may have a plurality of disks coupled together vertically within the recess 108. Above and below the magnetic medium 110 are read/write heads 114 are provided which are capable of moving above and below the surface of the magnetic medium 110.

The read/write heads 114 are attached to an actuator 116. The actuator 116 has a suspension 118 to dampen vibration and control oscillations of the read/write heads 114 near the end of the actuator 116 and to elastically bias the actuator 116 toward the magnetic medium 110.

One end of the actuator 116 opposite of the read/write heads 114 has a swing arm 120 mounted to a pivot bearing 122. The pivot bearing 122 provides consistency of elevation and smoothness of movement for the actuator 116 to move laterally over the surface of the magnetic medium 110.

Driving the actuator 116 is a voice coil motor 124. The voice coil motor 124 provides rotational motion to position the read/write heads 114 above and below the surface of the magnetic medium 110. The voice coil motor 124 may provide both clockwise and counterclockwise rotational motion to the actuator 116.

An opening 126 in the base 102 is provided to allow a circuit board (not shown) to be mounted below the base 102 and signal conduits (not shown) to pass from the circuit board to the elements of the hard disk drive system 100 within the recess 108.

Mounted within the recess 108 adjacent to the actuator 116 and the voice coil motor 124 is an adsorbent breather assembly 128. The adsorbent breather assembly 128 provides pressure equalization and filtration of air within the recess 108 of the base 102. The adsorbent breather assembly 128 is directly coupled to the base 102 and is in direct contact therewith.

Above the base 102 is shown a cover 130 that mounts above the base 102. The cover 130 can be held in place with coupling bolts 132. A perimeter 134 of the cover 130 can align to a gasket 136 that is attached to upper surfaces of the sidewalls 106. The gasket 136 provides reduced vibration and acoustic harmonic reduction. An air hole 138 is further shown in the cover 130 and can be aligned with the adsorbent breather assembly 128 when the cover 130 is mounted to the base 102.

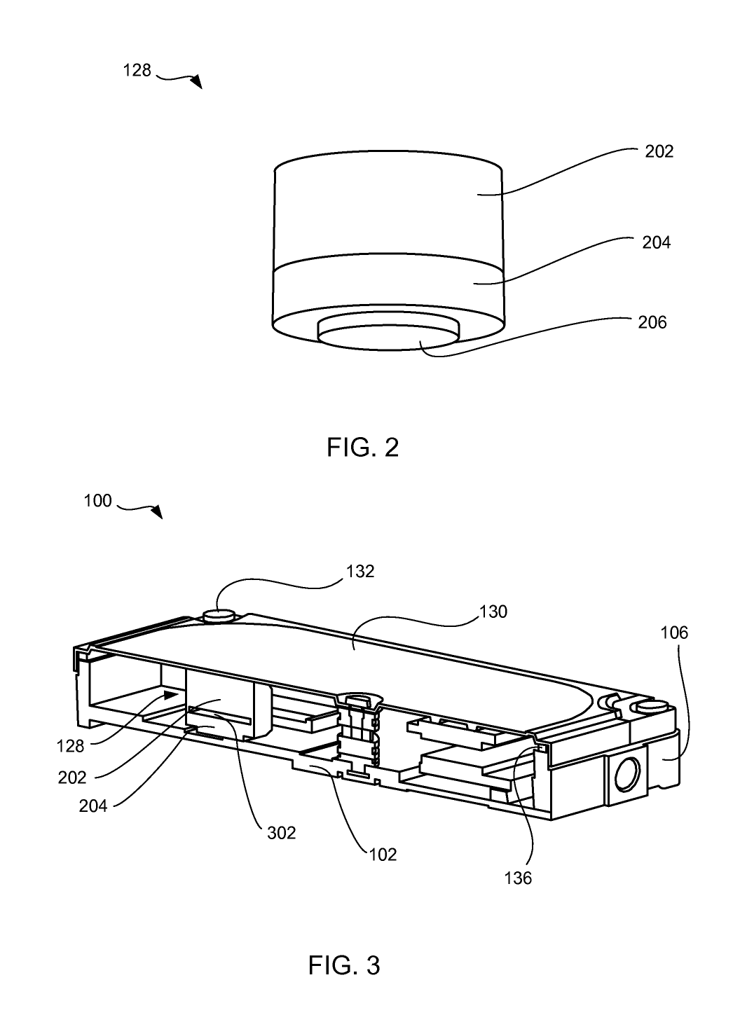

Referring now to FIG. 2, therein is shown an isometric view of the adsorbent breather assembly 128 of the hard disk drive system 100 of FIG. 1. The adsorbent breather assembly 128 is shown having a filter 202 and an understructure 204.

The filter 202 is depicted as being a homogenous structure. For the purposes of this description, a homogenous structure is defined as being of uniform material or composition throughout the structure.

It has been discovered that production and implementation of a homogenous structure as the filter 202 reduces process steps, reduces process time, and reduces material cost of producing the component while simultaneously reducing the defect rate of the component.

The understructure 204 may be a damping member, a spacer, another filter or function as any combination thereof. Further, the understructure 204 functions to provide stability and support for the filter 202. The understructure 204 should be designed to reduce acute stress on the filter 202 that may cause a breakdown of the filter 202 due to its homogenous structure.

It has been discovered that the filter 202 coupled with and reinforced by the understructure 204 may provide an effective and simple support structure. The material composition of the filter 202 may be carbon. The material composition of the understructure 204 may be engineering plastics or metals.

Mounted below the understructure 204 is a disk 206. The disk 206 is an adhesive or should function as an alignment guide for accurate placing of the adsorbent breather assembly 128 during assembly of the hard disk drive system 100 of FIG. 1. The disk 206 can also do both. The disk 206 can also function as an adhesive to lock the adsorbent breather assembly 128 into position during assembly of the hard disk drive system 100. The disk 206 can also be a portion of the understructure 204, itself and not a separate component.

Referring now to FIG. 3, therein is shown a cutaway isometric view of the hard disk drive system 100 along the line 3-3 of FIG. 1. The hard disk drive system 100 is shown having the cover 130 affixed to the base 102 with the coupling bolts 132. The gasket 136 is shown compressed between the sidewalls 106 of the base 102 and the cover 130. The stiffness of the filter 202 may be adjusted by the addition of cavities 302 within the filter 202.

Mounted between the cover 130 and the base 102 is the adsorbent breather assembly 128. The adsorbent breather assembly 128 is positioned in direct contact with the base 102 and in direct contact with the cover 130 and attached to the cover with an adhesive. When the cover 130 is mounted over the base 102 the coupling bolts 132 introduce tension into the cover 130 as a downward vertical force. The adsorbent breather assembly 128 acts as a pillar, introducing an opposite and upwards vertical force to the cover 130.

It has been discovered that this tension introduced into the cover 130 using direct contact with the adsorbent breather assembly 128 greatly enhances the stiffness of the base 102 and cover 130. This additional stiffness lessens the amount of deformation observed in the cover 130 and base 102 during testing and operation of the hard disk drive system 100.

This reduction of deformation in the cover 130 and base 102 enhances the performance of the hard disk drive system 100 by allowing for smaller tolerances between the magnetic medium 110 of FIG. 1 and the heads 114 of FIG. 1. Tighter tolerances provide increased read signal quality and write saturation of the magnetic medium 110.

Further, it has been discovered that utilizing the adsorbent breather assembly 128 as a pillar reduces the risk that the cover 130 will deform to such an extent to contact the magnetic medium 110 of FIG. 1. The implementation of the adsorbent breather assembly 128 as a pillar therefore introduces greater tolerance control into the manufacturing and assembly of parts of the hard disk drive system 100.

The filter 202 is shown as being in direct contact with the cover 130. The adsorbent breather assembly 128 is further shown having the understructure 204 in direct contact with the base 102 and leaving no space or gap therebetween. It has been discovered that the direct contact of the adsorbent breather assembly 128 between the base 102 and the cover 130 further functions to reduce manufacturing steps and component count of the final product by removing spacers and gaps.

Although the understructure 204 is shown in direct contact with the base 102, the filter 202 may extend entirely to make direct contact with the base 102 leaving no gap between the filter 202 and the base 102. It has been further discovered that utilizing the adsorbent breather assembly 128 as a pillar between the cover 130 and the base 102 reduces the directional deformation of the cover 130 during testing to deformations of between −0.086 mm to −0.311 mm. The reduction of directional deformation also resulted in a marked reduction of acoustic vibration in the cover 130 and the base 102.

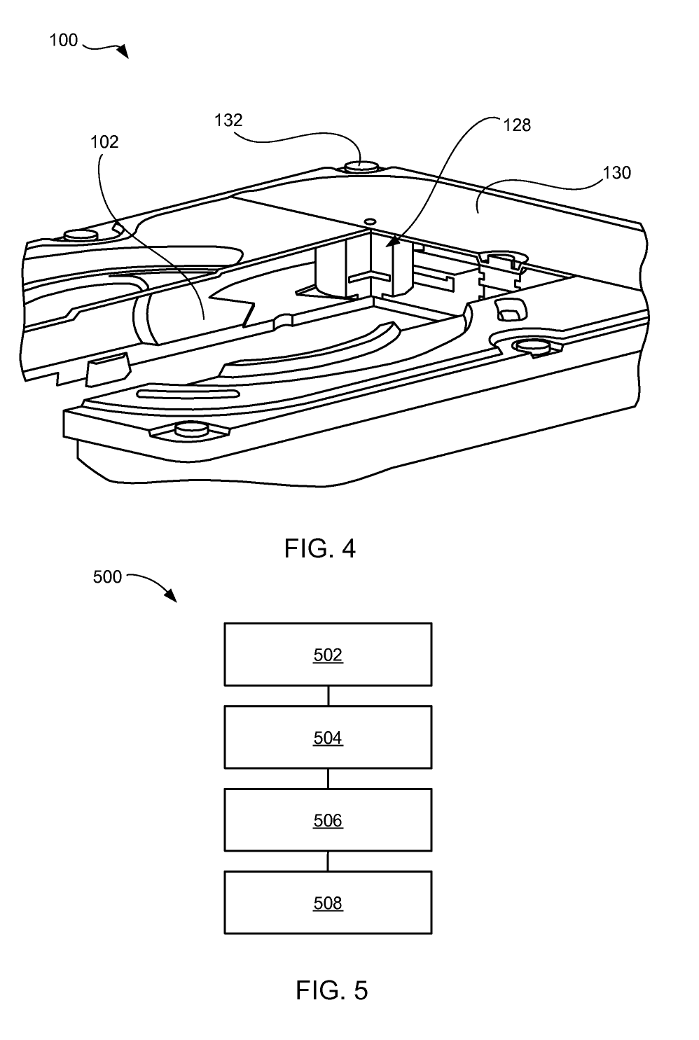

Referring now to FIG. 4, therein is shown a cutaway isometric view of the hard disk drive system 100 along the line 4-4 of FIG. 1. The hard disk drive system 100 is shown having the cover 130 affixed to the base 102 with the coupling bolts 132.

Mounted between the cover 130 and the base 102 is the adsorbent breather assembly 128. The adsorbent breather assembly 128 is positioned in direct contact with the base 102 and in direct contact with the cover 130. The adsorbent breather assembly 128 equalizes pressure differences between the internal and external environment.

The adsorbent breather assembly 128 further diverts airflow between components within the hard disk drive system 100. The adsorbent breather assembly 128 is may be of any shape such as a cuboid, cylinder, triangular prism, cone, or sphere shape so long as it remains in direct contact with the cover 130 and the base 102 to provide effective stiffness.

It has been discovered that the shape of the adsorbent breather assembly 128 may be used to improve and channel airflow within the hard disk drive system 100 by diverting air flow to improve the effect of tunneling magnetoresistive components of the heads 114 of FIG. 1. This is due to the increased control of the temperature in the transducer region (not shown) of the heads 114 of FIG. 1.

The adsorbent breather assembly 128 is also capable of mounting directly to a conventional base 102 and cover 130 without necessitating a redesign of these components. This provides cost effective implementation by foregoing new design and testing phases since proven designs may be used effectively.

Referring now to FIG. 5, therein is shown a flow chart of a method 500 of manufacture of the hard disk drive system 100 of FIG. 1. The method 500 includes providing a base having sidewalls in a block 502; mounting a magnetic medium for storing data within the sidewalls in a block 504; mounting an adsorbent breather assembly in direct contact with the base and mounted within the sidewalls without contact therewith in a block 506; and mounting a cover having an airhole over the base and the sidewalls, in direct contact with the adsorbent breather assembly in a block 508.

Thus, it has been discovered that the adsorbent breather assembly of the present invention furnishes important and heretofore unknown and unavailable solutions, capabilities, and functional aspects for hard disk drive system configurations. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of manufacture of a hard disk drive system comprising:
providing a base having sidewalls;
mounting a magnetic medium for storing data within the sidewalls;
mounting an adsorbent breather assembly in direct contact with the base and mounted within the sidewalls without contact therewith; and
mounting a cover having an airhole over the base and the sidewalls, in direct contact with the adsorbent breather assembly.

2. The method as claimed in claim 1 wherein:
mounting the cover in direct contact with the adsorbent breather assembly includes affixing the cover to the base with tension induced within the cover by direct contact with the adsorbent breather assembly.

3. The method as claimed in claim 1 wherein:
mounting the adsorbent breather assembly includes mounting the adsorbent breather assembly having a filter in direct contact with the base.

4. The method as claimed in claim 1 wherein:
mounting the adsorbent breather assembly includes mounting the adsorbent breather assembly having a cuboidial shape, cylinderical shape, coneical shape, spherical shape, or a combination thereof for channeling airflow performance.

5. The method as claimed in claim 1 wherein:
mounting the adsorbent breather assembly includes mounting the adsorbent breather assembly having a homogenous structure.

6. A method of manufacture of a hard disk drive system comprising:
providing a base having sidewalls;
mounting a magnetic medium, for storing data, within the sidewalls;
mounting an adsorbent breather assembly having a filter and an understructure, and with the understructure in direct contact with the base and the adsorbent breather assembly is within the sidewalls and without contact therewith; and
mounting a cover having an air hole over the base and the sidewalls in direct contact with the filter of the adsorbent breather assembly.

7. The method as claimed in claim 6 wherein:
mounting the cover having the air hole includes mounting the cover having the air hole in alignment with the adsorbent breather assembly.

8. The method as claimed in claim 6 wherein:
mounting the adsorbent breather assembly having the understructure includes mounting the adsorbent breather assembly having the understructure as a damping member, a spacer, a filter, or a combination thereof.

9. The method as claimed in claim 6 wherein:
mounting the cover in direct contact with the adsorbent breather assembly reduces deformation and dampens acustic vibration of the cover.

10. The method as claimed in claim 6 wherein:
mounting the adsorbent breather assembly having the understructure includes mounting the understructuer having a disk functioning as an adhesive, an alignment guide, or a combination thereof.

11. An integrated circuit packaging system comprising:
a base having sidewalls;
a magnetic medium for storing data mounted within the sidewalls;
an adsorbent breather assembly mounted in direct contact with the base and mounted within the sidewalls without contact therewith; and
a cover having an airhole mounted over the base and the sidewalls, in direct contact with the adsorbent breather assembly.

12. The system as claimed in claim 11 wherein:
the cover is affixed to the base with tension induced within the cover by direct contact with the adsorbent breather assembly.

13. The system as claimed in claim 11 wherein:
the adsorbent breather assembly is mounted having a filter in direct contact with the base.

14. The system as claimed in claim 11 wherein:
the adsorbent breather assembly has a cuboidial shape, cylinderical shape, coneical shape, spherical shape, or a combination thereof for channeling airflow performance.

15. The system as claimed in claim 11 wherein:
the adsorbent breather assembly has a homogenous structure.

16. The system as claimed in claim 11 wherein:
the adsorbent breather assembly has a filter and an understructure, and with the understructure in direct contact with the base; and
the cover is in direct contact with the filter of the adsorbent breather assembly.

17. The system as claimed in claim 16 wherein:
the cover has the air hole in alignment with the adsorbent breather assembly.

18. The system as claimed in claim 16 wherein:
the adsorbent breather assembly has the understructure as a damping member, a spacer, a filter, or a combination thereof.

19. The system as claimed in claim 16 wherein:
the cover in direct contact with the adsorbent breather assembly reduces deformation and dampens acustic vibration of the cover.

20. The system as claimed in claim 16 wherein:
the understructuer has a disk functioning as an adhesive, an alignment guide, or a combination thereof.
